(19) United States
(12) Patent Application Publication
(10) Pub. No.: US 2009/0134794 A1
(43) Pub. Date: May 28, 2009

(54) Plasma display panel

(76) Inventors: Ji-Suk Kim, Suwon-si (KR); Jae-Young Park, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/290,833

(22) Filed: Nov. 4, 2008

(30) Foreign Application Priority Data
Nov. 28, 2007 (KR) 10-2007-0122193

(51) Int. Cl. H01J 17/49

(52) U.S. Cl. 313/584

(57) ABSTRACT

Disclosed is a plasma display panel capable of reducing light reflection on screen. The present embodiments provide a plasma display panel provided with discharge spaces between a front panel, a rear panel and barrier ribs and including a phosphor layer formed in the discharge space, wherein the front panel includes a front substrate; a plurality of striped pattern regions provided in a first surface of the front substrate that faces the rear panel, and extended toward a first direction; a plurality of first pattern regions provided in a second surface of the front substrate and formed with a pattern in which the striped pattern regions are orthogonally projected to the second surface of the front substrate, and with the same pattern in a position that is overlapped with the pattern region; and a plurality of second pattern regions provided in the second surface of the front substrate and crossed with the first pattern regions.

### CROSS-REFERENCE TO RELATED APPLICATION

This application claims priority to and the benefit of Korean Patent Application No. 10-2007-0122193 filed on Nov. 28, 2007 in the Korean Intellectual Property Office, the entire content of which is incorporated herein by reference.

### BACKGROUND OF THE INVENTION

1. Field of the Invention

The present embodiments relate to a plasma display panel having a pattern region formed on a front substrate to reduce light reflection on screen.

2. Description of the Related Art

In general, a plasma display panel refers to a display device for displaying an image by injecting discharge gas into a space between two substrates in which a plurality of electrodes are formed, sealing the space, and applying a discharge voltage to two electrodes to allow them to emit the light.

Plasma display panels can be divided into a DC plasma display panel and an AC plasma display panel depending on the form of drive voltage that is applied to discharge cells, for example, the discharge form. Also, the plasma display panel may be divided into an opposed discharge type and a surface discharge type depending on the configuration of electrodes.

FIG. 1 is a partial cross-sectional perspective view showing a conventional plasma display panel, which is disclosed in Korean Patent Laid-open Publication No. 10-2004-0020094.

As shown in FIG. 1, the conventional plasma display panel is formed by sealing a rear substrate 102 and a front substrate 114 to each other, wherein an address electrode 104, a dielectric layer 106 and a barrier rib 108 are formed on the rear substrate 102, and sustain electrodes 110 and 112 are formed on the front substrate 114.

The address electrode 104 is formed on the rear substrate 102, and the dielectric layer 106 is formed on the rear substrate 102 on which the address electrode 104 is formed. A plurality of the barrier ribs 108 are formed on the dielectric layer 106 to maintain a sustain distance and prevent electro-optical cross-talks between cells.

Also, the sustain electrodes 110 and 112 are formed in a facing inner surface of the rear substrate 102, and disposed spaced apart from a predetermined distance from address electrode 104, and the rear substrate 102 being arranged vertically to the address electrode 104 formed in the rear substrate 102.

Such sustain electrodes 110 and 112 are made of transparent indium tin oxide (ITO) to constitute display electrodes. Bus electrodes 110a and 112a are formed respectively on the sustain electrodes 110 and 112 to reduce line resistance, wherein the bus electrodes 110a and 112a have narrow widths than those of the corresponding sustain electrodes 110 and 112.

Phosphor layers 116 are formed in lateral sides of the barrier ribs 108 and on the dielectric layer 106 that is exposed between the barrier ribs 108. Also, a dielectric layer 118 in which the electrodes 110, 112, 110a and 112a are buried is formed in a bottom surface of the front substrate 114. For the plasma display panel as described above, the bus electrodes 110a and 112a, which are formed respectively on the transparent sustain electrodes 110 and 112 formed on the front substrate 114, are made of metals. Therefore, the bus electrodes 110a and 112a are formed on edges of the sustain electrode 110 and 112 as slimly as possible so as to minimize interception of the light that is emitted by the phosphor layer 116.

The bus electrode 110a and 112a is formed respectively on the sustain electrodes 110 and 112 according to a printing method using a metal material, for example, silver (Ag) paste, and a photolithographic method using a photosensitive film.

Black stripes 120 for shielding ambient light are formed around the sustain electrodes 110 and 112. Here, problems regarding the conventional method for shielding ambient light will be described in detail with reference to the FIG. 2.

FIG. 2 is a cross-sectional view showing a portion of the front substrate as shown in FIG. 1. Loci on which ambient light is incident and reflected are shown as solid-line arrows, and the ambient lights absorbed by the black stripes are shown as dotted-line arrows, as shown in FIG. 2. However, FIG. 2 is shown without any of considerations of the refraction of light in different media.

According to the above fact, the black stripe 120 in the plasma display panel shields some of the ambient light that is incident to the front substrate 114, for example only ambient light that is incident to the black stripe 120. Here, the ambient light shielded thus is presented as dotted lines. And, the remaining ambient light (as presented as solid-line arrows) is reflected, which leads to the degraded contrast ratio.

Accordingly, the ability to shield the ambient light is increased with increasing width of the black stripes 120, but the excessively large width of the black stripes 120 may cause the reduction of a transmission region of indicator light, which leads to the deteriorated luminance.

A separate electromagnetic wave shielding layer including a metal mesh layer is attached to the front surface of a front panel to shield electromagnetic waves generated in driving the conventional plasma display panel, as disclosed in Korean Patent Laid-open Publication No 10-2006-0080116. However, the separate electromagnetic wave shielding layer has problems that a thickness of a panel may be increased with the increase in the manufacturing cost of the panel. The present embodiments address the above problems with display panels as well as provide additional advantages.

### SUMMARY OF THE INVENTION

Accordingly, the present embodiments are designed to solve such drawbacks of the prior art, and therefore an object of the present embodiments is to provide a plasma display panel capable of improving contrast by shielding the ambient light.

Another object of the present embodiments is to provide a plasma display panel that does not include a separate electromagnetic wave shielding layer.

One aspect of the present embodiments is achieved by providing a plasma display panel provided with discharge spaces between a front panel, a rear panel and barrier ribs and including a phosphor layer formed in the discharge space, wherein the front panel includes a front substrate; a plurality of striped pattern regions provided in a first surface of the front substrate that faces the rear panel, and extended toward a first direction; a plurality of first pattern regions provided in a second surface of the front substrate and formed with a pattern in which the striped pattern regions are orthogonally projected to the second surface of the front substrate, and with the same pattern in a position that is overlapped with the pattern region; and a plurality of second pattern regions provided in the second surface of the front substrate and crossed with the first pattern regions.

Another aspect of the present embodiments is achieved by providing a plasma display panel including a front panel including a front substrate, a sustain electrode formed on a first surface of the front substrate and a first dielectric layer for burying the sustain electrode; a rear panel facing the front panel and including a rear substrate, an address electrode in which the rear substrate is formed in a surface that faces the front substrate, a second dielectric layer for burying the address electrode and a passivation layer for protecting the dielectric layer, all of which are formed on the surface that faces the front substrate; a barrier rib for dividing a discharge space between the front panel and the rear panel into certain patterns; and a phosphor layer provided in the inner part of the discharge space, wherein the first surface of the front substrate includes a plurality of striped pattern regions that are buried by the first dielectric layer and extended outwardly in a first direction, and the second surface of the front substrate includes a plurality of first pattern regions that are extended with the same pattern as the pattern region, and a plurality of second pattern regions that are crossed with the first pattern regions.

### BRIEF DESCRIPTION OF THE DRAWINGS

The accompanying drawings, together with the specification, illustrate exemplary embodiments, and, together with the description, serve to explain the principles of the present embodiments.

FIG. 1 is a partial cross-sectional perspective view showing a conventional plasma display panel.

FIG. 2 is a cross-sectional view showing a portion of a front substrate as shown in FIG. 1.

FIG. 3 is a partial exploded perspective view showing a configuration of a plasma display panel according to a first exemplary embodiment.

FIG. 4 is a cross-sectional view taken along line A-A′ of the front panel as shown in FIG. 3.

FIG. 5 is a cross-sectional view taken along line B-B′ of the front panel as shown in FIG. 3.

FIG. 6 is a diagram illustrating an operation of a plasma display panel according to one exemplary embodiment, as shown in FIG. 3.

FIG. 7 is a cross-sectional view showing a front panel of a plasma display panel according to a second exemplary embodiment.

FIG. 8 is a cross-sectional view showing one pixel of a plasma display panel according to a third exemplary embodiment.

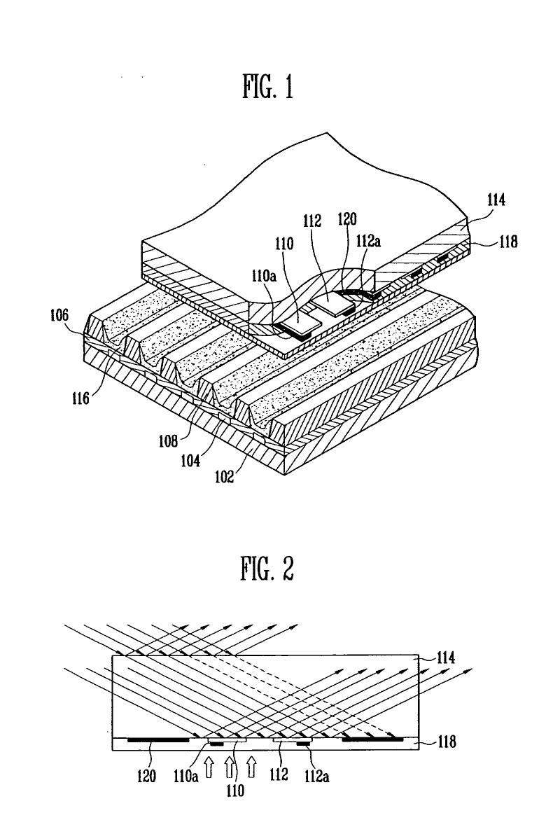

### DETAILED DESCRIPTION OF PREFERRED EMBODIMENTS

In the following detailed description, only certain exemplary embodiments have been shown and described, simply by way of illustration. As those skilled in the art would realize, the described embodiments may be modified in various different ways, all without departing from the spirit or scope of the present embodiments. Accordingly, the drawings and description are to be regarded as illustrative in nature and not restrictive. In addition, when an element is referred to as being “on” another element, it can be directly on the element or be indirectly on the element with one or more intervening elements interposed therebetween. Also, when an element is referred to as being “connected to” another element, it can be directly connected to the element or be indirectly connected to the element with one or more intervening elements interposed therebetween. Hereinafter, like reference numerals refer to like elements.

Hereinafter, it is considered that the same components in the description have the same reference numerals for convenience′ sake of their descriptions.

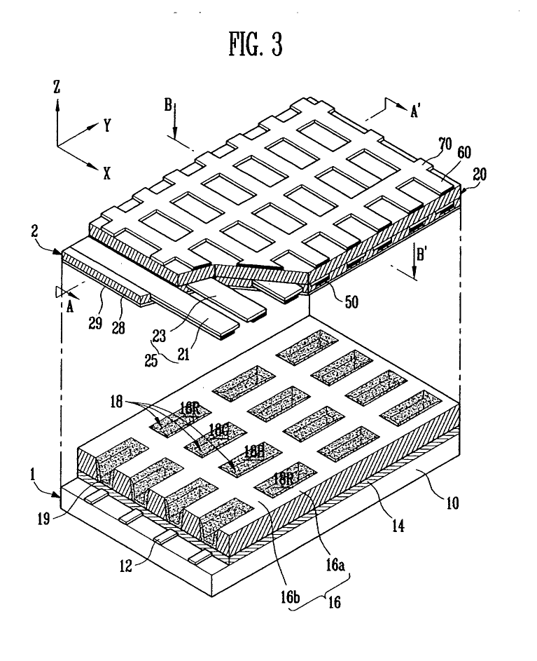

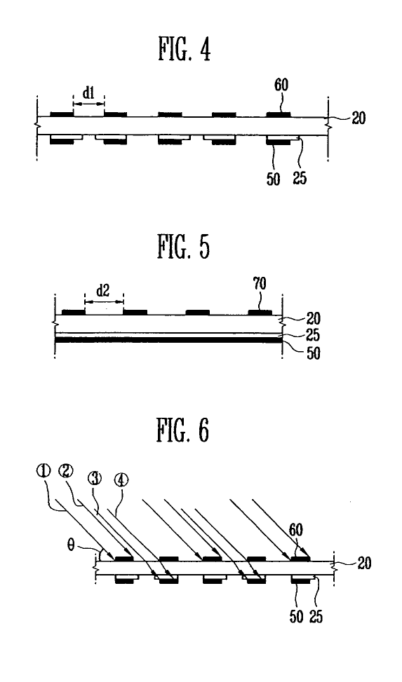

FIG. 3 is a partial exploded perspective view showing a configuration of a plasma display panel according to the first exemplary embodiment. FIG. 4 is a cross-sectional view taken along line A-A′ of the front panel as shown in FIG. 3, and FIG. 5 is a cross-sectional view taken along line B-B′ of the front panel as shown in FIG. 3. The front panel 2 will be described in detail. The front panel 2 includes a front substrate 20, a sustain electrode 25, a first dielectric layer 28, and a passivation layer 29.

In some embodiments, the front substrate 20 is disposed to face the rear substrate 10 at a predetermined distance. Color discharge cells 18 (18R, 18G and 18B) formed by barrier ribs 16 (16a and 16b) are provided in a space between the substrates 10 and 20. Also, a phosphor layer 19 that excites ultraviolet rays in the discharge cells 18 to emit a visible ray is formed along surfaces of the barrier ribs and a bottom surface, and filled with a discharge gas (e.g., a mixture gas containing xenon (Xe), neon (Ne), etc.) to give rise to plasma discharge. The front substrate 20 is formed of transparent materials, such as, glass, that can transmit a visible ray to display an image.

The front substrate 20 is formed on the first surface that faces the rear substrate 10 so that the sustain electrodes 25 can correspond respectively to the discharge cells 18 along one direction (x-axis direction in the drawings). Each of the sustain electrodes 25 is composed of an X electrode 21 and a Y electrode 23. The X electrode 21 selects a discharge cell 18 that is turned on by reaction of the address electrode 12, and the Y electrode 23 generates sustain discharge to the discharge cell 18 that is selected by the reaction with the X electrode 21.

Pattern regions 50 extended along the sustain electrode 25 are provided. In this exemplary embodiment, the pattern regions 50 may also function as a bus electrode to prevent voltage drop of the sustain electrode 25. The pattern regions 50 may be formed space apart at the same distance in this exemplary embodiment, but the present embodiments are not particularly limited thereto. Therefore, it is possible to vary the design of the plasma display panel. Also, the pattern region 50 may be made of metals.

The sustain electrodes 25 are buried by being covered by the first dielectric layer 28 that are formed of dielectric materials such as, for example, PbO, B₂O₃, SiO₂, etc. The first dielectric layer 28 prevents charged particles from colliding with the sustain electrodes 25 in the discharge process, thereby preventing the damage of the sustain electrodes 25. Also, the first dielectric layer 28 functions to induce the charged particles.

A lower surface of the first dielectric layer 28 may be covered by a passivation layer 29 formed of, for example, MgO or the like. The passivation layer 29 prevents charged particles from colliding with a first dielectric layer 28 in the discharge process, thus to prevent the damage of the first dielectric layer 28. Also, the passivation layer 29 may function to enhance discharge efficiency since the passivation layer 29 emits secondary electrons when the passivation layer 29 collides with the charged particles.

A plurality of first and second conductive pattern regions 60 and 70 are provided in a second surface of the front substrate 20. Here, the first conductive pattern regions 60 are formed in a pattern where the pattern regions 50 provided in the first surface of the front substrate 20 are orthogonally projected toward a second surface of the front substrate 20, e.g., with the same pattern in a position that is overlapped with the pattern regions 50 on the first surface, and the second conductive pattern regions are formed such that they can be crossed with the first conductive pattern regions 60.

The fact that the first conductive pattern regions 60 are formed with the same pattern as the pattern regions 50 includes the fact that the pattern regions 50 are substantially identical to the first conductive pattern regions 60, as well as a fact that the distance or width of the pattern regions 50 are substantially identical to those of the first conductive pattern regions 60 to realize the advantageous effects of the present embodiments.

The second conductive pattern regions 70 are crossed with the first conductive pattern regions 60. In this exemplary embodiment, the intersecting angle is about 90°, but the present embodiments are not limited thereto and cover intersecting angles at 0° 10°, 20°, 30°, 40°, 50°, 60°, 70+, 80°, 90°, 110°, 120°, 130°, 140°, 150°, 160°, 170°, or 180°, for example. Also, a distance (d2) between the second conductive pattern regions 70 is preferably wider than a distance (d1) between the first conductive pattern regions 60.

The second conductive pattern regions 70 may be freely designed to improve efficiency of external light, unlike the first conductive pattern regions 60 having a pattern that is dependent on the pattern region 50, and therefore it is advantageous to lengthen the distance between patterns in consideration of the efficiency of external light.

The first conductive pattern regions 60 and the second conductive pattern regions 70 may be made of conductive materials, for example metals, (e.g., gold or silver), and therefore they function to intercept electromagnetic waves. At the same time, the pattern regions 50, the first conductive pattern regions 60 and the second conductive pattern regions 70 play a role in shielding the ambient light, for example, absorbing light.

A distance (d2) between the second conductive pattern regions 70 is wider than a distance (d1) between the first conductive pattern regions 60. And, the first conductive pattern regions 60 and the second conductive pattern regions 70 preferably have a thickness of 1 to 50 μm.

Also, the first conductive pattern regions 60 and the second conductive pattern regions 70 are made of conductive materials to shield electromagnetic waves, and therefore the plasma display panel of the present embodiments does not need a separate electromagnetic wave shielding layer in this exemplary embodiment.

This exemplary embodiment discloses that the first and second conductive pattern regions 60 and 70 are carved in relief, but it is possible to intaglio the first and second conductive pattern regions 60 and 70. However, when the first and second conductive pattern regions 60 and 70 are intagliated, an additional process of etching the first surface of the front substrate 20 into grooves is required.

Next, a rear panel 1 includes a rear substrate 10, an address electrode 12 and a second dielectric layer 14. Address electrodes 12 are arranged on the rear substrate 10 that faces the front substrate 20. The address electrodes 12 are extended respectively toward a direction that they are crossed with the sustain electrodes 25 (y-axis direction in the drawings), and arranged spaced apart with each other to correspond respectively to the discharge cells. The address electrodes 12 are buried by being covered by the second dielectric layer 14. Barrier ribs 16 are formed on the second dielectric layer 14 with a predetermined pattern.

The barrier ribs 16 function to prevent cross talks between the adjacent discharge cells 18 by dividing the discharge cells 18 as the discharge spaces into compartments. The barrier ribs 16 include vertical barrier ribs 16a and horizontal barrier ribs 16b, and define the discharge cells 18 in closed structures, as shown in FIGS. 3, 4 and 5. Here, the vertical barrier ribs 16a are extended spaced apart from each other. The horizontal barrier ribs 16b are formed on the same plane surface as the vertical barrier ribs 16a, and extended spaced apart from each other in a direction where they are crossed with the vertical barrier ribs 16a.

However, such configuration of the barrier ribs has been described as one exemplary embodiment, but the present embodiments are not limited thereto. For example, it is evident that various configuration of striped barrier ribs, for example, which are arranged between the address electrodes 12 and formed in parallel with the address electrodes 12, are also possible.

A phosphor layer 19 is formed inside each of the discharge cells 18, the phosphor layer 19 being excited by ultraviolet rays generated during a discharge process to emit a visible ray. The phosphor layer 19 is formed over walls of the barrier rib 16 and a lower surface of the second dielectric layer 14 that is defined by the barrier rib 16, as shown in FIGS. 3, 4 and 5.

The phosphor layer 19 may include one phosphor selected from red, green and blue phosphors so as to express colors. Therefore, the phosphor layer 19 may be divided into sub-phosphor layers: red, green, blue phosphor layers 18R, 18G and 18B. Each of the discharge cells 18 having the phosphor layers 19 arranged as described above is filled with a discharge gas including, for example, neon (Ne), xenon (Xe), etc.

FIG. 6 is a diagram illustrating an operation of the plasma display panel according to one exemplary embodiment, as shown in FIG. 3. Referring to FIG. 6, when a plasma display panel is irradiated with the ambient light, the ambient light is intercepted by the pattern regions 50 formed on the first surface of the front substrate 20, and the first conductive pattern regions 60 formed on the second surface of the front substrate 20.

When an incidence angle (θ) at which the ambient light is incident to the plasma display panel is set to an average angel of 45°, the lights \textcircled{1} and \textcircled{2} that are incident from the outside are absorbed by the first conductive pattern regions 60 provided in the first surface of the front substrate 20, and the light rays \textcircled{3} and the \textcircled{4} are absorbed by the pattern regions 50 provided in the second surface of the front substrate 20. As a result, it is possible to intercept all of the ambient light that is incident to the plasma display panel.

Each of the distances between the pattern regions (the first and second conductive pattern regions 60 and 70) may be easily set by those skilled in the art, in consideration of the combinations of the configuration of sustain electrodes and the shielding ratio of the ambient light.

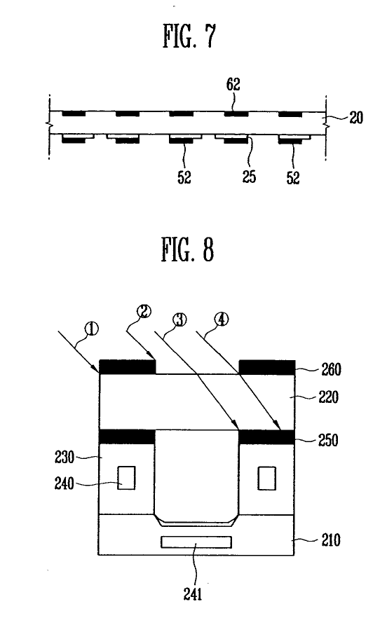

FIG. 7 is a cross-sectional view showing a front panel of the plasma display panel according to a second exemplary embodiment. This exemplary embodiment has the same construction as the first embodiment is slightly different from the first embodiment in that the first conductive pattern regions 62 and the second conductive pattern regions (not shown) are intagliated.

Pattern regions 62 are formed by forming grooves in the second surface of the front substrate 20 and filling the grooves with colored substances. The components that are overlapped with the first embodiment are omitted in this exemplary embodiment.

FIG. 8 is a cross-sectional view showing one pixel of the plasma display panel according to a third exemplary embodiment.

The third exemplary embodiment discloses that the present embodiments apply to an opposed discharge-type plasma display panel. For such third exemplary embodiment, the plasma display panel includes a rear substrate 210; a front substrate 220; barrier ribs formed as dielectric layers 230 between the front substrate 220 and the rear substrate 210; first discharge electrodes 240 formed inside the barrier ribs; and second discharge electrodes 241 formed in the rear substrate 210.

In this embodiment, pattern regions 250, which function as “black stripes” to intercept the ambient light on the dielectric layer 230, are formed in a first surface of the front substrate 220. First conductive pattern regions 260 and second conductive pattern regions (not shown), which have the same pattern as the pattern regions 250 in the first surface of the front substrate 220, are formed in a second surface of the front substrate 220 to intercept the ambient light rays \textcircled{1}, \textcircled{2}, \textcircled{3} and \textcircled{4} to a desired level. The plasma display panel according to the present embodiments may not need a separate electromagnetic wave shielding layer.

The present embodiments have been described in detail with reference to the exemplary embodiments. However, it is understood that various modifications and equivalent arrangements of the embodiments be made without departing from the spirit and scope of the appended claims.

Some of the surface discharge type and the opposed discharge type that are applicable to the present embodiments have been described in detail in these exemplary embodiments, but the subject matter of the present embodiments may be applied without any limitation of the discharge structures.

The plasma display panel according to the present embodiments may be useful to shield electromagnetic waves without installing a separate electromagnetic wave shielding layer, and to effectively intercept the ambient light.

While the present embodiments have been described in connection with certain exemplary embodiments, it is to be understood that the present embodiments are not limited to the disclosed embodiments, but, on the contrary, is intended to cover various modifications and equivalent arrangements included within the spirit and scope of the appended claims, and equivalents thereof.

What is claimed is:

1. A plasma display panel comprising discharge spaces between a front panel, a rear panel and barrier ribs and comprising at least one phosphor layer formed in the discharge spaces, wherein the front panel comprises:
a front substrate;
a plurality of striped pattern regions provided on a first surface of the front substrate that faces the rear panel, and extended toward a first direction;
a plurality of first pattern regions provided on a second surface of the front substrate and formed with a pattern in which the striped pattern regions are orthogonally projected to the second surface of the front substrate, and with the same pattern in a position that overlaps with at least one pattern region; and
a plurality of second pattern regions provided on the second surface of the front substrate crossed with the first pattern regions.

2. The plasma display panel according to claim 1, wherein the first pattern regions vertically cross to the second pattern regions.

3. The plasma display panel according to claim 1, wherein the pattern regions are made of metals or polymers that can absorb light.

4. The plasma display panel according to claim 1, wherein the first pattern regions and the second pattern regions are made of conductive materials that can absorb light.

5. The plasma display panel according to claim 1, wherein the distance between the second pattern regions is wider than the distance between the first pattern regions.

6. The plasma display panel according to claim 1, wherein the first pattern regions and the second pattern regions are carved in relief.

7. The plasma display panel according to claim 1, wherein the first pattern regions and the second pattern regions are intagliated.

8. A plasma display panel, comprising:
a front panel comprising a front substrate, a sustain electrode formed on a first surface of the front substrate and a first dielectric layer burying the sustain electrode;
a rear panel facing the front panel and comprising a rear substrate, an address electrode in which the rear substrate is formed on a surface that faces the front substrate,
a second dielectric layer configured to bury the address electrode and a passivation layer configured to protect the dielectric layer, all of which are formed on the surface that faces the front substrate;
a barrier rib dividing a discharge space between the front panel and the rear panel into certain patterns; and
a phosphor layer provided in the inner part of the discharge space,
wherein the first surface of the front substrate comprises a plurality of striped pattern regions that are buried by the first dielectric layer and extended outwardly in a first direction, and
wherein the second surface of the front substrate comprises a plurality of first pattern regions that are extended with the same pattern as the pattern region, and a plurality of second pattern regions that are crossed with the first pattern regions.

9. The plasma display panel according to claim 8, wherein the first pattern regions vertically cross the second pattern regions.

10. The plasma display panel according to claim 8, wherein the pattern regions are made of metals or polymers that can absorb light.

11. The plasma display panel according to claim 8, wherein the first pattern regions and the second pattern regions are made of conductive materials that can absorb light.

12. The plasma display panel according to claim 8, wherein the pattern regions comprise bus electrodes of the sustain electrode.

13. The plasma display panel according to claim 8, wherein a distance between the first pattern regions is narrower than the distance between the second pattern regions.

14. The plasma display panel according to claim 8, wherein the first pattern regions and the second pattern regions are carved in relief.

15. The plasma display panel according to claim 8, wherein the first pattern regions and the second pattern regions are intagliated.
